(19) United States
(12) Patent Application Publication
(10) Pub. No.: US 2007/0185269 A1
(43) Pub. Date: Aug. 9, 2007

(54) Rubber composition for puncture-preventive sealant, pneumatic tire having tacky sealant layer, and process for producing the same

(75) Inventors: Takashi Fukutomi, Hiratsuka-shi (JP); Takumi Sekiguchi, Hiratsuka-shi (JP); Issei Nakakita, Hiratsuka-shi (JP); Mitsuru Naito, Hiratsuka-shi (JP); Yuichi Kobayashi, Hiratsuka-shi (JP); Tetsuo Ikegami, Shinshiro-shi (JP); Satoshi Makino, Wako-shi (JP); Takayuki Toyoshima, Wako-shi (JP); Tetsuya Mizone, Wako-shi (JP); Naoya Miyawaki, Wako-shi (JP)

Correspondence Address: RADER FISHMAN & GRAUER PLLC, LION BUILDING, 1233 20TH STREET N.W., SUITE 501, WASHINGTON, DC, 20036, US

(73) Assignees: THE YOKOHAMA RUBBER CO., LTD., Tokyo (JP); HONDA GIKEN KOGYO KABUSHIKI KAISHA, Tokyo (JP)

(21) Appl. No.: 11/727,458

(22) Filed: Mar. 27, 2007

Related U.S. Application Data
(62) Division of application No. 10/486,501, filed on Feb. 11, 2004, now abandoned.

(30) Foreign Application Priority Data
Sep. 26, 2001 (JP) 2001-294172
Aug. 22, 2002 (JP) 2002-242366

(51) Int. Cl. C08F 8/00

(52) U.S. Cl. 525/192

(57) ABSTRACT

A sealant rubber composition which forms a spongy tacky sealant layer having moderate viscosity properties; and a pneumatic tire having in the tire main body a tacky sealant layer obtained by heating the rubber composition. The rubber composition comprises 0.2 to 20 parts by weight of a peroxide per 100 parts by weight of polymers comprising 95 to 50 parts by weight of a polymer decomposable with the peroxide and 5 to 50 parts by weight of a polymer crosslinkable with the peroxide.

### TECHNICAL FIELD

The present invention relates to a rubber composition for a puncture-preventive sealant and a pneumatic tire having a tacky sealant layer. More specifically, the present invention relates to a rubber composition for creating a sealant having moderate viscosity properties to prevent a puncture, a pneumatic tire having in the tire main body a spongy tacky sealant layer obtained by heating the rubber composition, and a process for producing the same.

### BACKGROUND ART

Conventionally proposed measures for a puncture of a tire when the tire rolls on a nail or the like while driving are: (1) a run-flat tire in which a rigid portion is inserted into the tire; (2) a process for sealing a puncture by injecting a liquid-like mending agent into a tire from an air valve upon puncture; (3) a process for superposing a tacky sealant on the inner surface of a tire in advance upon tire production; and the like.

However, the run-flat tire of (1) has problems that the weight thereof is increased by a rigid material, resulting in increase riding discomfort. A problem of the process for injecting a mending liquid of (2) is not as serious as the run-flat tire of (1), in terms of weight increase. However, there is a problem that a driver must go outside the car to inject the liquid upon puncture.

The process of (3) has advantages over the run-flat tire of (1) and the process of (2), in which the problem of weight increase as in the run-flat tire of (1) is settled, and the process of (3) is capable of self-sealing without having a person inject the liquid upon puncture.

An example of the process of (3), which has advantages over the run-flat tire of (1) and the process of (2), is proposed in Japanese Patent Laid-Open Publication No. 53-55802, in which a rubber composition having a peroxide added to polyisobutylene is disposed on the inner surface of the tire and heated to be decomposed upon tire vulcanization to obtain a tacky sealant.

Nevertheless, in the technique described in the publication, polyisobutylene is decomposed further, and liquid-like polybutene itself compounded as an adhesive is decomposed by a peroxide in a tacky sealant obtained by heating and decomposing polyisobutylene with a peroxide. Thus, the viscosity of the sealant is extremely reduced. Accordingly, when the sealant is disposed on the inner surface of the tire, the stickiness to a nail piercing the sealant becomes poor as the viscosity is reduced. Therefore, there has been a problem in that the sealing properties become poor.

### DISCLOSURE OF THE INVENTION

An object of the present invention is to provide a rubber composition for a puncture-preventive sealant, which is capable of forming a spongy tacky sealant layer having moderate viscosity properties when a tacky sealant is created by heating a composition of a polymer which is decomposable with a peroxide and a peroxide, a pneumatic tire having in the tire main body a tacky sealant layer obtained by heating the rubber composition, and a process for producing the same.

The rubber composition for a puncture-preventive. sealant to form the spongy sealant layer having moderate viscosity properties comprises 0.2 to 20 parts by weight of a peroxide per 100 parts by weight of polymers comprising 95 to 50 parts by weight of a polymer decomposable with the peroxide and 5 to 50 parts by weight of a polymer crosslinkable with the peroxide.

The pneumatic tire with excellent puncture-preventive function has in the tire main body a tacky sealant layer obtained by heating a rubber composition, which comprises 0.2 to 20 parts by weight of a peroxide per 100 parts by weight of polymers, wherein the polymers comprise 95 to 50 parts by weight of a polymer decomposable with the peroxide and 5 to 50 parts by weight of a polymer crosslinkable with the peroxide.

Moreover, this pneumatic tire of the present invention is efficiently produced by heating a rubber composition and vulcanizing other members of the tire at the same time when a tacky sealant layer is formed in the tire main body by heating the rubber composition, which comprises 0.2 to 20 parts by weight of a peroxide per 100 parts by weight of polymers, wherein the polymer comprise 95 to 50 parts by weight of a polymer decomposable with the peroxide and 5 to 50 parts by weight of a polymer crosslinkable with the peroxide.

### BRIEF DESCRIPTION OF THE DRAWINGS

FIG. 1 is a meridian half sectional view of a pneumatic tire of the present invention.

FIG. 2 is an explanatory view showing a state where a nail pierces the pneumatic tire in FIG. 1.

### BEST MODES FOR CARRYING OUT THE INVENTION

Hereinafter, the present invention is detailed further. The present invention is characterized in that a polymer decomposable with a peroxide and a polymer crosslinkable with a peroxide are used together in a specific range. Specifically, when a rubber composition of the present invention is heated in the presence of a peroxide, the polymer decomposable with a peroxide is decomposed at the same time as that the polymer crosslinkable with a peroxide is crosslinked. In addition, as the polymer decomposable with a peroxide is decomposed, low molecular-weight olefin gas is generated. Thus, the crosslinkable polymer becomes a lattice, and the rubber composition becomes spongy. Meanwhile, the spongy tacky sealant layer has moderate viscosity properties obtained by decomposing the polymer decomposable with a peroxide. As a result, the obtained spongy tacky sealant can give excellent puncture-preventive functionality to the tire. Further, it is possible to lighten the tire itself.

In the present invention, the polymer decomposable with a peroxide exhibits rubber-like viscosity by being heated in the presence of the peroxide. Examples of the polymer include polyisobutylene and polypropylene. Among those, polyisobutylene is preferred. Herein, polyisobutylene includes a polymer which is copolymerized with a small amount of isoprene or the like. In the case of polymerization, polyisobutylene with not more than 2.2 mol % of insaturation is normally used.

Next, the polymer crosslinkable with a peroxide of the present invention is a polymer which is crosslinked when it is heated with a peroxide added. Examples of the polymer include natural rubber, styrene-butadiene rubber (SBR), butadiene rubber (BR), nitrile butadiene rubber (NBR) and ethylene-propylene-diene terpolymer (EPDM).

In addition, it is necessary to compound 0.2 to 20 parts by weight of a peroxide in the rubber composition per 100 parts by weight of the polymers decomposable and crosslinkable with the peroxide. When the amount of peroxide is less than 0.2 parts by weight, the polymer decomposable with a peroxide, such as polyisobutylene, is not sufficiently decomposed. Moreover, the crosslinking of the polymer crosslinkable with a peroxide does not sufficiently develop. Thus, the puncture-preventive properties are not sufficiently realized. When the amount of peroxide exceeds 20 parts by weight, the added amount of peroxide is extremely large. Accordingly, the rate of decomposition progresses excessively, and the viscosity of the resulting tacky composition becomes extremely low. Therefore, the puncture-preventive properties are not sufficiently realized.

Examples of the peroxide include acyl peroxides such as benzoyl peroxide and P-chlorobenzoyl peroxide, ketone peroxides such as methylethylketone peroxide, peroxyesters such as t-butylperoxyacetate, t-butylperoxybenzoate and t-butylperoxyphthalate, and alkyl peroxides such as dicumyl peroxide, di-t-butylperoxybenzoate, 1,3-bis (t-butylperoxy isopropyl) benzene, and hydroperoxides such as t-butylhydroperoxide. Dicumyl peroxide is especially preferred.

To the rubber composition used for the creation of the tacky sealant in the present invention, a catalyst such as cobalt naphthenate which accelerates the decomposition of a polymer by a peroxide, an inorganic filler such as carbon black and silica, an adhesive such as polybutene, or a plasticizer such as aromatic series process oil, naphthene series process oil and paraffin series process oil may be added as necessary. However, clay is not preferred because the clay hinders the decomposition of the peroxide.

Moreover, the thickness of the tacky sealant layer preferably ranges from 1 to 8 mm, and more preferably from 1 to 4 mm. It is not preferable that the tacky sealant layer be thinner than 1 mm because the puncture-preventive effects will be reduced, or thicker than 8 mm because the tire weight will increase.

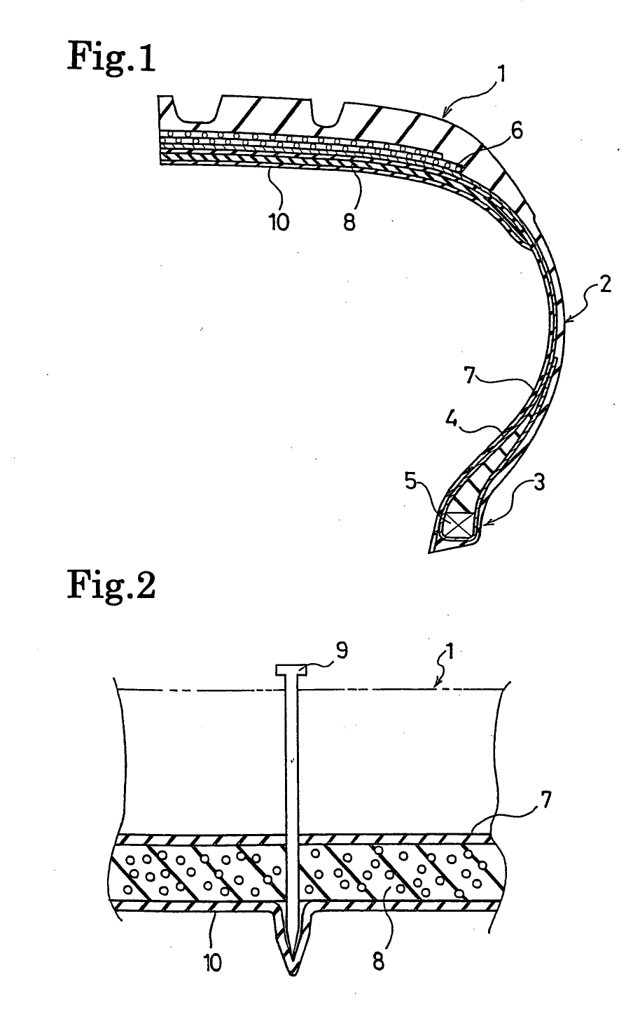

Hereinafter, the constitution of a tire of the present invention is detailed with reference to the drawings. FIG. 1 is a meridian half sectional view showing an example of a pneumatic tire of the present invention. Reference numerals 1, 2 and 3 denote a tread, a sidewall and a bead, respectively. A carcass layer 4 is disposed in the inner side of the tire, and both ends of the carcass layer 4 are connected to a bilateral pair of bead cores 5, 5. Belt layers 6 are provided on the periphery of the carcass layer 4 in the tread 1. An inner liner 7 is disposed in the inner side of the carcass layer 4. A spongy tacky sealant layer 8 is disposed in the inner side of the inner liner 7 at a position corresponding to the tread. A cover sheet rubber layer 10 is disposed on the inner side of the tacky sealant layer 8.

Butyl rubber, which exhibits excellent impermeability, is generally used for the inner liner 7. Alternatively, a thermoplastic resin film may be used. The cover sheet rubber layer 10 is effective for maintaining a uniform tacky sealant layer over the entire inner surface of the tire. The thickness of the cover sheet rubber layer 10 preferably ranges from 0.5 to 2.0 mm. The cover sheet rubber layer 10 is formed by natural rubber, BR, SBR or the like.

The process for producing the pneumatic tire thus structured includes a step of disposing a rubber composition to the inner surface of an unvulcanized tire in the process for producing a normal pneumatic tire. The rubber composition has 0.2 to 20 parts by weight of a peroxide per 100 parts by weight of polymers, wherein the polymers comprise 95 to 50 parts by weight of a polymer decomposable with the peroxide and 5 to 50 parts by weight of a polymer crosslinkable with the peroxide. By heating the rubber composition and vulcanizing other members at the same time, the rubber composition forms a spongy tacky sealant layer having moderate viscosity in the tire main body through thermal decomposition and crosslinkable reaction. At this time, the provision of the cover sheet rubber layer on the inner surface of the sealant layer is effective for maintaining a uniform tacky sealant layer over the entire inner surface of the tire.

In the process for producing a normal pneumatic tire, vulcanization is performed after a bladder is inserted into the inner side of the tire. The bladder acts as a pressurizing means. However, in the present invention, it is preferable to maintain the radius of the pressurized bladder at a radius which contracts in conjunction with an increase in the thickness of the tacky sealant layer, so as to permit an increase in the thickness of the tacky sealant layer on the inner portion of the tire, resulting in a tacky sealant layer having a predetermined thickness upon the termination of the vulcanization. Thus, it is possible to control the thickness of the tacky sealant layer to obtain a tacky sealant layer of uniform thickness.

Since the foregoing tacky sealant layer foams by the generation of gas accompanying the decomposition of the polymers upon the termination of the vulcanization, there is a possibility that the resulting thickness of the tacky sealant layer will be uneven if the bladder is contracted rapidly. By maintaining the bladder in a state where the bladder is slightly contracted in a radial direction by decompression, the tacky sealant layer is foamed to have uniform thickness. For example, when the initial thickness of the tacky sealant layer is t₁ (mm) and the target thickness is t₂ (mm), a radius R of the bladder should be contracted by an increase in the thickness of the tacky sealant layer (t₂−t₁). When the bladder is maintained at the slightly contracted position, the maintenance time should be set to 10 to 120 seconds.

By the pneumatic tire having the tacky sealant layer of the present invention, the puncture-less effects can be obtained as follows: as shown in FIG. 2, a nail 9 pierces the tire from the tread 1 to the tacky sealant layer 8 in the inner side of the tire through the inner liner 7. In this case, the cover sheet rubber layer 10 changes its shape into a triangle, and the tacky sealant layer 8 on the inner surface sticks to the nail 9 so as to hermetically seal the puncture. Thus, the leakage of air is prevented. Moreover, when the nail 9 comes off by centrifugal force caused by high-speed driving, the tacky sealant layer 8 stuck to the periphery of the nail 9 is drawn to the puncture of the tread 1 to seal the puncture. Therefore, air will not leak.

### EXAMPLE

Hereinafter, the present invention is detailed by giving examples. Note that viscosity in Examples and Comparison Examples were evaluated by the following measurement method.

An iron rod (14Φ=154 mm²) made of SS400 (the same material used for the nail) was gently touched on the tacky surface at the surface pressure of 1 g/mm², and separation power was measured after one minute. In the present invention, when the separation power was not less than 40 kPa, the viscosity was determined to satisfy the application level.

### Example 1

A pneumatic tire provided with a tacky sealant layer, in which the tire size thereof is 205/65R15, the thickness of the tacky sealant layer is 3 mm, and the thickness of the cover sheet rubber layer is 1 mm, was produced through vulcanization for 20 minutes at 160° C. by use of a sealant rubber composition formed by the following components.

| Material Compounded With Rubber Composition | Parts by Weight |
|---|---|
| Polyisobutylene | 95 |
| Natural Rubber | 5 |
| FEF (Carbon Black) | 30 |
| Aromatic Oil | 10 |
| Peroxide (Dicumyl Peroxide) | 15 |

The sponge formation state of the tacky sealant layer of the obtained tire was visually evaluated. The viscosity was measured and evaluated by the aforementioned method. The results are listed in Table 1. As for the sponge formation in Table 1, number 1 indicates the case where a good-quality sponge was formed. Number 2 indicates the case where a sponge was formed. Number 3 indicates the case where a sponge hardly existed.

### Example 2

Unlike in Example 1, the compounding amount of polyisobutylene was set to 65 parts by weight and the compounding amount of natural rubber, the crosslinkable polymer, was set to 35 parts by weight. Otherwise, the tacky layer was formed in the same way as in Example 1. The results are listed in Table 1.

### Comparison Example 1

Unlike in Example 1, the compounding amount of polyisobutylene was set to 98 parts by weight and the compounding amount of natural rubber, the crosslinkable polymer, was set to 2 parts by weight. Otherwise, the tacky layer was formed in the same way as in Example 1. The results are listed in Table 1.

### Comparison Example 2

Unlike in Example 1, the compounding amount of polyisobutylene was set to 45 parts by weight and the compounding amount of natural rubber, the crosslinkable polymer, was set to 55 parts by weight. Otherwise, the tacky layer was formed in the same way as in Example 1. The results are listed in Table 1.

### Example 3

Unlike in Example 1, 50 parts by weight of polypropylene was used instead of polyisobutylene, which is a polymer decomposable with a peroxide. Instead of natural rubber, which is a crosslinkable polymer, 50 parts by weight of EPDM was used. Other than these changes, the tacky sealant layer was formed in the same way as in Example 1. The results are listed in Table 1.

TABLE 1

| | Decomposable | | | |
|---|---|---|---|---|
| | Polymer | Crosslinkable Polymer | Sponge Formation | Viscosity |
| Example 1 | 95 Parts by Weight | 5 Parts by Weight of | 2 | 65 kPa |
| | of Polyisobutylene | Natural Rubber | | |
| Example 2 | 65 Parts by Weight | 35 Parts by Weight of | 1 | 51 kPa |
| | of Polyisobutylene | Natural Rubber | | |
| Comparison | 98 Parts by Weight | 2 Parts by Weight of | 3 | 75 kPa |
| Example 1 | of Polyisobutylene | Natural Rubber | | |
| Comparison | 45 Parts by Weight | 55 Parts by Weight of | 1 | 12 kPa |
| Example 2 | of Polyisobutylene | Natural Rubber | | |
| Example 3 | 50 Parts by Weight | 50 Parts by Weight of | 1 | 68 kPa |
| | of Polypropylene | EPDM | | |

Hereinbefore, the preferred embodiment of the present invention has been detailed. However, it should be understood that various changes, substitutions and replacements can be made therein without departing from spirit and scope of the inventions as defined by the appended claims.

### INDUSTRIAL APPLICABILITY

In the present invention, by using a polymer decomposable with a peroxide and a polymer crosslinkable with a peroxide together at a specific ratio, a spongy tacky sealant having moderate viscosity can be formed through a thermal process under the existence of the peroxide. Thus, it is possible to give excellent puncture-preventive function to a tire and lighten the tire itself.

1. (canceled)

2. (canceled)

3. (canceled)

4. A process for producing a pneumatic tire, wherein, when a tacky sealant layer is formed in a tire main body by heating a rubber composition comprising 0.2 to 20 parts by weight of a peroxide per 100 parts by weight of polymers comprising 95 to 50 parts by weight of a polymer decomposable with the peroxide and 5 to 50 parts by weight of a polymer crosslinkable with the peroxide, the rubber composition is heated at the same time as that other members of the tire are vulcanized.

5. The process for producing a pneumatic tire according to claim 4, wherein, in the process for producing a pneumatic tire in which vulcanization is performed while a bladder is inserted into an inner side of the tire as pressurizing means, upon the termination of the vulcanization, the bladder is maintained at a position contracted by an increase in thickness of the tacky sealant layer as to increase the thickness of the tacky sealant layer to a predetermined thickness.
